(19) United States
(12) Patent Application Publication
(10) Pub. No.: US 2017/0324085 A1
(43) Pub. Date: Nov. 9, 2017

(54) Precursor for Producing Lithium-rich Cathode Active Material, and Lithium-rich Cathode Active Material Produced Thereby

(71) Applicants: Orange Power Ltd., Daejeon (KR); Korea Electronics Technology Institute, Seongnam-si (KR)

(72) Inventors: Young Jin Hong, Daejeon (KR); Jae Hoon Lee, Seoul (KR); Young Jae Lee, Daejeon (KR); Jun Ho Song, Seongnam-si (KR); Young Jun Kim, Yongin-si (KR); Yeon Hee Kim, Seoul (KR); Eun Ah Lee, Seoul (KR)

(21) Appl. No.: 15/662,017

(22) Filed: Jul. 27, 2017

Related U.S. Application Data
(62) Division of application No. 14/871,067, filed on Sep. 30, 2015.
Application No. 14/871,067 is a continuation-in-part of application No. PCT/KR2014/002746, filed on Mar. 31, 2014.
Application No. PCT/KR2014/002746 is a continuation-in-part of application No. PCT/KR2014/002748, filed on Mar. 31, 2014.

(30) Foreign Application Priority Data
Mar. 30, 2013 (KR) 10-2013-0034929
Mar. 30, 2013 (KR) 10-2013-0034930
Dec. 5, 2013 (KR) 10-2013-0150314
Dec. 5, 2013 (KR) 10-2013-0150316

(51) Int. Cl. H01M 4/36; H01M 4/525; H01M 4/505; C01G 53/00; H01M 10/0525

(52) U.S. Cl. CPC H01M 4/366; C01G 53/50; C01G 53/006; H01M 4/525; H01M 4/505; C01P 2002/72; C01P 2004/03; C01P 2004/51; C01P 2006/40; H01M 10/0525; C01P 2004/61

(57) ABSTRACT

The disclosure relates to a precursor manufacturing a lithium rich cathode active material and a Lithium rich cathode active material using the same, more specifically relates to a novel precursor for manufacturing a lithium rich cathode active material of which capacity properties and cycle life characteristics are considerably improved by solving a problem of conventional lithium rich cathode active material, and a Lithium rich cathode active material using the same.

### CROSS-REFERENCE TO RELATED APPLICATIONS

This application is a divisional of U.S. application Ser. No. 14/871,067, filed on Sep. 30, 2015, which is a continuation-in-part of International application Ser. PCT/KR2014/002746, filed on Mar. 31, 2014, which claims priority from Korean Patent Application No. 10-2013-0034929, filed on Mar. 30, 2013, and Korean Patent Application No. 10-2013-0150314, filed on Dec. 5, 2013. U.S. application Ser. No. 14/871,067, filed on Sep. 30, 2015, is also a continuation-in-part of International application Ser. No. PCT/KR2014/002748, filed on Mar. 31, 2014, which claims priority from Korean Patent Application No. 10-2013-0034930, filed on Mar. 30, 2013, and Korean Patent Application No. 10-2013-0150316, filed on Dec. 5, 2013. The disclosures of each of the foregoing are incorporated herein by reference in their entirety.

### FIELD OF THE INVENTION

The inventive concepts relate to a precursor manufacturing a lithium rich cathode active material and a Lithium rich cathode active material manufactured using the same, and more specifically relates to a novel precursor for manufacturing a lithium rich cathode active material of which capacity properties and cycle life characteristics are considerably improved by solving problems of conventional lithium rich cathode active material and a Lithium rich cathode active material manufactured using the same.

### BACKGROUND

Lithium batteries are widely utilized in electric home appliances because of relatively high energy density. Rechargeable batteries are generally referred to secondary batteries, and lithium secondary batteries usually include anode material introducing Lithium.

Presently, lithium containing cobalt oxide such as LiCoO₂ of layered structure, lithium containing nickel oxide such as LiNiO₂ of layered structure or lithium containing manganese oxide such as LiMnO₂ of spinel structure is used for cathode activate material of the lithium ion secondary battery, and graphite material is mostly used for anode active material.

LiCoO₂ is being widely employed at present because various properties such as cycle life characteristic are excellent, but there is limit to use in large quantity for a power source in such a field of electric vehicle because its stability is low and cobalt is short in resources and expensive. Therefore, it is difficult to introduce LiNiO₂ in a practical mass product process at a rational cost because of characteristics in manufacturing method.

In contrast, the lithium manganese oxides such as LiMnO₂, LiMn₂O₄ are rich in resources, have advantage of using manganese with environment affinity and then becoming the center of interest as cathode active materials capable of replacing LiCoO₂. However, these lithium manganese oxides also have disadvantage that cycle life characteristics is inferior. LiMnO₂ has disadvantages of small initial capacity and needs dozens of charge/discharge cycles to reach specific capacity.

Further, the capacity of LiMn₂O₄ is more seriously declined as repeating the cycles, and more specifically cycle characteristic is rapidly declined by manganese eruption and electrolyte dissolution at a temperature over 50° C.

Recently, it has been suggested that Li₂MnO₃ is introduced to elevate stability of layered base cathode active material and to increase theoretical available capacity. This cathode active material has properties in which a plane section appears at a high voltage section between 4.3V to 4.6V. This plane section is found where lithium and oxygen are desorbed from a crystal structure of Li₂MnO₃ and lithium is inserted into an anode. Li₂MnO₃ may not be used as an insertion electrode of the lithium battery because an insertion site of tetrahedral structure facing octahedral structure is inefficient to receive additional lithium. It is impossible to extract Lithium because a manganese ion is 4-valent and not oxidized easily in real potential. But, according to Materials Research Bulletin (Volume 26, page 463 (1991)), Rossouw et al., Li₂O is removed from Li₂MnO₃ structure by a chemical treatment producing Li₂₋ₓMnO_{3-x/2} thereby activating Li₂MnO₃ electrochemically, and this process is accompanied by a little H⁺-Li⁺ ion exchanges. According to Journal of Power Sources (Volume 80, page 103 (1999)), Kalyani et al. and Chemistry of Materials (Volume 15, page 1984, (2003)), Robertson et al., Li₂MnO₃ is also activated electrochemically by removing Li₂O from a lithium battery. However, this activated electrode is not preferable to performance of lithium battery.

As described above, the lithium battery tends to lose in capacity when a Li₂₋ₓMnO_{3-x/2} electrode is solely used. However, U.S. Pat. Nos. 6,677,082 and 6,680,143 disclose that a composite electrode, for example, two components electrode system such as xLi₂MnO₃.(1-x)LiMO₂(M=Mn, Ni, Co) in which Li₂MnO₃ and LiMO₂ components are layered structure, is used thereby improving electrochemical properties and having high efficiency.

There is electrochemical activation caused by lithium and oxygen desorption at the high voltage section of 4.3V through 4.6V and capacity may be increased by existing of the plane section, even if the cathode active material of the composite electrode structure is used, however, oxygen gas is generated in the battery to raise possibility of electrolyte dissolution and gas generation under high voltage and crystal structure is physically and chemically deformed by frequent charging/discharging such that rate capability is declined. As a result, there is a problem that the performance of battery is declined

Further, a tail section of discharge voltage becomes lower such that it cannot contribute to capacity for mobile phones, or it is impossible for practical battery to achieve high output because the power for vehicles is insufficient to be at an invalid SOC (State Of Charge) region.

Therefore, there is a growing necessity of technology to solve these problems basically.

### SUMMARY

The present invention is objected to remedy the problems of the prior lithium rich cathode active material, and to provide a novel precursor for manufacturing lithium rich cathode active material of which capacity properties and cycle life characteristics are improved remarkably and lithium rich cathode active material using the same.

In order to solve the above-described problems, the present invention provides a precursor for manufacturing lithium rich cathode active material expressed by following chemical formula 1 or 2:

Ni_{α1}Mn_{β1}Co_{γδ1}A_{δ1}CO₃ [Chemical formula 1]

(In the chemical formula 1, A is at least 1 or 2 selected from the group consisting B, Al, Ga, Ti and In; α1 is 0.05 to 0.4; β1 is 0.5 to 0.8; γ1 is 0 to 0.4; and δ1 is 0.001 to 0.1), and

Ni_{α2}Mn_{β2-y2}Co_{γ2-δ2}Al_{δ2}A_{y2}CO₃ [Chemical formula 2]

(In the chemical formula 2, A is at least 1 or 2 selected from the group consisting Mg, Ti and Zr; α2 is 0.05 to 0.4; β2 is 0.5 to 0.8; γ2 is 0 to 0.4; δ1 is 0.001 to 0.1; and y2 is 0.001 to 0.1).

The particle diameter of the precursor for manufacturing lithium rich cathode active material is 5 to 25 μm.

In the precursor for manufacturing lithium rich cathode active material according to the present invention, A of the chemical formula 1 is Al.

The present invention also provides lithium rich cathode active material expressed by following chemical formula 3, which is manufactured from the precursor for manufacturing lithium rich cathode active material,

Li₁₋ₓNi_{α1}Mn_{β1}Co_{γ1-δ1}A_{δ1}O₂ [Chemical formula 3]

(In the chemical formula 3, x is 0.4 to 0.7; A is at least one or two selected from the group consisting B, Al, Ga, Ti and In; α is 0.05 to 0.4; β1 is 0.5 to 0.8; γ1 is 0 to 0.4; and δ1 is 0.001 to 0.1).

The lithium rich cathode active material according to the present invention is expressed by xLiNi_{α1}Mn_{β1}Co_{γ1-δ1}A_{δ1}O₂.(1-x)Li₂MO₃(0<x<1, M is a compound of Ni, Co, and Mn; and A is at least one or two selected from the group consisting B, Al, Ga, Ti and In). In the lithium rich cathode active material according to the present invention, A is Al.

Namely, lithium rich cathode active material according to the present invention consists of layered bases expressed by LiNi_{α}Mn_{β}Co_{γ-δ}A_{δ}O₂ and Li₂MO₃, and different metal A displaces Co in the layered base expressed by LiNi_{α}Mn_{β}Co_{γ-δ}A_{δ}O₂ to improve high voltage life properties of the layered base expressed by LiNi_{α}Mn_{β}Co_{γ-δ}A_{δ}O₂. During charging/discharging, metal ions such as A moves and disperses between layers to stabilize hexagonal structure, and to prevent Ni⁺² ions from oxidizing into +3-valent or +4-valent ions. However, if the different metal A displaces Co excessively, output and capacity may be declined by decreasing Co content. Therefore, displacement amount of the different metal is preferable to 0.001 to 0.1.

The lithium rich cathode active material according to the present invention is a layered structural composite or a solid solution.

In the lithium rich cathode active material according to the present invention, A content: δ1, Li content: x1, Mn content: ⊕1, Ni content: α1 and Co content: γ1-δ1 satisfy following relative formula,

X1≧δ1 and

B1≧3(x1+α1+γ1−δ1)

The present invention further provides lithium rich cathode active material which is expressed by following chemical formula and manufactured by the precursor for manufacturing lithium rich cathode active material,

Li₁₊ₓ₂Ni_{α2}Mn_{β2-y2}Co_{γ2-δ2}Al_{δ2}A_{y2}O₂ [Chemical formula 3]

(In the chemical formula 4, x2 is 0.2 to 0.7; A is selected from the group consisting Mg, Ti, and Zr; α2 is 0.05 to 0.4; β2 is 0.5 to 0.8; γ2 is 0 to 0.4; δ2 is 0.001 to 0.1; and y2 is 0.001 to 0.1).

The lithium rich cathode active material according to the present invention is expressed by xLiMAl_{δ2}O₂.(1-x)Li₂Mn_{1-y2}A_{y2}O₃ (0<x<1, M is a compound of Ni, Co, and Mn; A is selected from the group consisting Mg, Ti, and Zr; δ2 is 0.001 to 0.1; and y2 is 0.001 to 0.1). Namely, the lithium rich cathode active material according to the present invention consists of layered bases expressed by LiMAl_{δ2}O₂ and Li₂Mn_{1-y2}A_{y2}O₃, and different metal Al displaces M in the layered base expressed by LiMAl_{δ2}O₂ and different metal A displaces Mn in the layered base expressed by Li₂MnO₃. Therefore, the different metal A participate electro-chemical activation of the Li₂MnyO₃ to improve high voltage life properties and prevent Mn eruption, simultaneously.

In the chemical formula 4, when M is Co, it is preferred that the replacement amount of Al is 0.001 to 0.1 because output and capacity are declined by decreasing Co content if the different metal A displaces Co position excessively.

It is preferred that the displacement amount of the different metal A is 0.001 to 0.1 because capacity is declined if A displaces Mn excessively. It is more preferred that the displacement amount of the different metal A is 0.02 to 0.05.

In the lithium rich cathode active material according to the present invention, in the chemical formula 4, Al content: δ2, Li content: x2 and different metal A content: y2 satisfy following relative formula,

X2≧δ2 and

Y2≧δ2

The lithium rich cathode active material according to the present invention is layered structural composite or solid solution state.

The lithium rich cathode active material according to the present invention has particle intensity of at least 115 Mpa.

### BRIEF DESCRIPTION OF THE DRAWINGS

The inventive concepts will become more apparent in view of the attached drawings and accompanying detailed description.

FIG. 1 shows SEM images of precursor particles for manufacturing lithium rich cathode active material which is fabricated by an embodiment of the present invention;

FIG. 2 shows EDS analyses about sections of precursor particles for manufacturing lithium rich cathode active material which is fabricated by an embodiment of the present invention;

FIG. 3 shows SEM images of precursor particles for manufacturing lithium rich cathode active material which is fabricated by an embodiment of the present invention;

FIG. 4 shows EDS analyses about sections of precursor particles for manufacturing lithium rich cathode active material which is fabricated by an embodiment of the present invention;

FIG. 5 shows a XRD analysis about particles of lithium rich cathode active material which is fabricated by an embodiment of the present invention;

FIG. 6 shows a particle size analysis about particles of lithium rich cathode active material which is fabricated by an embodiment of the present invention;

FIGS. 7 through 9 show SEM images about particles of lithium rich cathode active material which is fabricated by an embodiment of the present invention;

FIGS. 10 through 12 show EDS analyses about particle sections of lithium rich cathode active material which is fabricated by an embodiment of the present invention;

FIGS. 13 through 15 show charging/discharging characteristics of batteries including lithium rich cathode active material which is fabricated by an embodiment of the present invention;

FIG. 16 shows cycle life characteristics of a battery including lithium rich cathode active material which is fabricated by an embodiment of the present invention;

FIG. 17 shows a XRD analysis about particles of lithium rich cathode active material which is fabricated by an embodiment of the present invention;

FIG. 18 shows a particle size analysis about particles of lithium rich cathode active material which is fabricated by an embodiment of the present invention;

FIGS. 19 through 21 show charging/discharging characteristics of batteries including lithium rich cathode active material which is fabricated by an embodiment of the present invention;

FIG. 22 shows cycle life characteristics of a battery including lithium rich cathode active material which is fabricated by an embodiment of the present invention;

FIGS. 23 and 24 show SEM images and EDS analyses of precursor for manufacturing lithium rich cathode active material which is fabricated by an embodiment of the present invention;

FIGS. 25 and 26 show SEM images and EDS analyses of precursor for manufacturing lithium rich cathode active material which is fabricated by an embodiment of the present invention;

FIGS. 27 and 28 show SEM images and EDS analyses of lithium rich cathode active material which is fabricated by an embodiment of the present invention;

FIGS. 29 and 30 show SEM images and EDS analyses of lithium rich cathode active material which is fabricated by an embodiment of the present invention; and

FIGS. 31 and 32 shows charging/discharging characteristics of a coin-half cell using lithium rich cathode active material which is fabricated by an embodiment of the present invention.

FIGS. 33 and 34 show cycle life characteristics of the coin-half cells using the lithium rich cathode active materials which are manufactured by an embodiment of the present invention.

### DETAILED DESCRIPTION OF THE EMBODIMENTS

The inventive concepts will now be described more fully hereinafter with reference to the accompanying drawings, in which exemplary embodiments of the inventive concepts are shown. The advantages and features of the inventive concepts and methods of achieving them will be apparent from the following exemplary embodiments that will be described in more detail with reference to the accompanying drawings. It should be noted, however, that the inventive concepts are not limited to the following exemplary embodiments, and may be implemented in various forms. Accordingly, the exemplary embodiments are provided only to disclose the inventive concepts and let those skilled in the art know the category of the inventive concepts. In the drawings, embodiments of the inventive concepts are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The present inventions will be described below in more detail with reference to exemplary embodiments. However, the inventive concept should not be construed as limited to the embodiments set forth herein.

### EXAMPLE 1

### Synthesis of a Precursor for Manufacturing Lithium Rich Cathode Active Material

Nickel sulfate hexahydrate (NiSO₄.6H₂O), cobalt sulfate heptahydrate (CoSO₄.7H₂O), manganese sulfate hydrate (MnSO₄.7H₂O), and metal compound solution containing aluminum sulfate as aluminum compound was poured into a coprecipitation reactor and continuously supplied to perform coprecipitation reaction for 50 hours while 28% ammonia solution as a complexing agent and Na₂CO₃ as a carbonate compound was continuously supplied to adjust pH as 8 to 10, and a slurry solution in the reactor was filtrated and washed by ultrapure distilled water followed by drying in a 110° C. vacuum oven for 12 hours, thereby nickel cobalt aluminum metal complex carbonate compound was obtained. This nickel cobalt aluminum metal complex carbonate compound was Ni_{0.2}Co_{0.07}Mn_{0.7}Al_{0.03}CO₃.

TABLE 1

| | Ni | Co | Mn | Al |
|---|---|---|---|---|
| Example 1-1 | 20 | 7 | 70 | 3 |
| Example 1-2 | 20 | 4 | 70 | 6 |
| Comparative Example 1 | 20 | 10 | 70 | 0 |
| Comparative Example 2 | 20 | 2 | 70 | 8 |

Precursor of the example 1-2 and the comparative examples 1, 2 were synthesized using the same condition except for manufacturing metal compound solution using compound rate in Table 1.

### Test Example 1-1

### SEM Imaging for Precursor

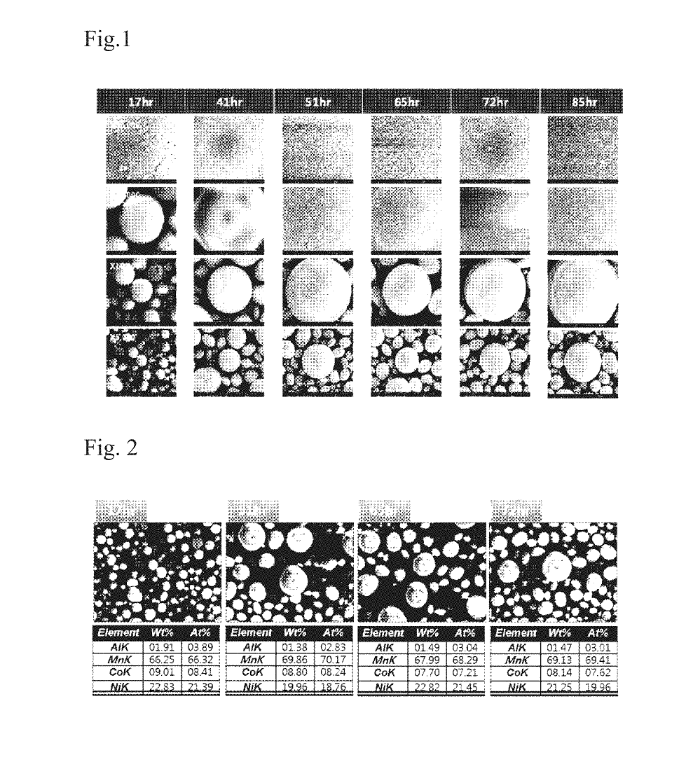

SEM images for precursor particles containing Al 3 mol %, which was manufactured in the example 1-1 were taken in accordance with synthesis time, and then the results were shown in FIG. 1. The precursor particles in FIG. 1 were spherical shape of 5 to 25 μm and had dense surfaces.

### Test Example 1-2

### EDS Analysis for Precursor

EDS analysis for a section of precursor containing Al 3 mol %, which was manufactured in the example 1-1 were performed in accordance with synthesis time, and then the results were shown in FIG. 2. Saturation amount of Al was maintained at 3 mol % during synthesis time.

### Test Example 1-3

### SEM Imaging for Precursor

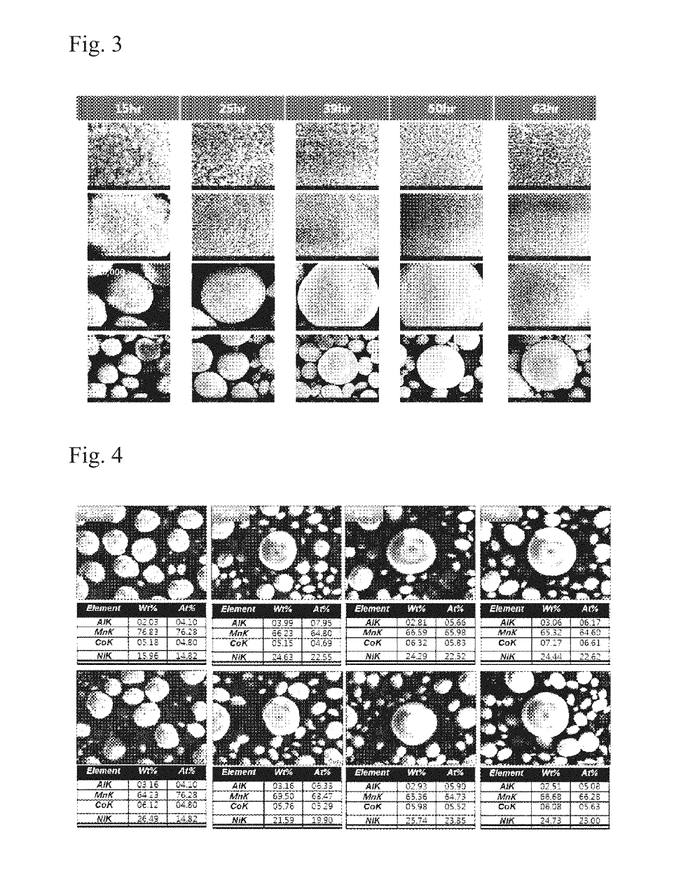

SEM images for precursor particles containing Al 6 mol %, which was manufactured in the example 1-2 were taken in accordance with synthesis time, and then the results were shown in FIG. 3. The precursor particles in FIG. 1 were spherical shape of 5 to 25 μm and had dense surfaces.

### Test Example 1-4

### EDS Analysis for Precursor

EDS analysis for a section of precursor containing Al 6 mol %, which was manufactured in the example 1-2 were performed in accordance with synthesis time, and then the results were shown in FIG. 4. Saturation amount of Al was maintained at 6 mol % during synthesis time.

### EXAMPLE 2

### Synthesis of Lithium Rich Cathode Active Material Containing Al 3 mol %

The carbonate precursor containing Al 3 mol% manufactured in the example 1-1 and Li₂CO₃ as a lithium compound were mixed at equivalent ratio, wherein transition metal ratio was in Table 2 followed by thermal treatment at 900° C. and pulverizing, thereby lithium rich cathode active material was synthesized.

TABLE 2

| | Li/(NiCoMnAl) |
|---|---|
| Example 2-1 | 1.40 |
| Example 2-2 | 1.45 |
| Example 2-3 | 1.50 |

### Test Example 2-1

### XRD Analysis for Active Material

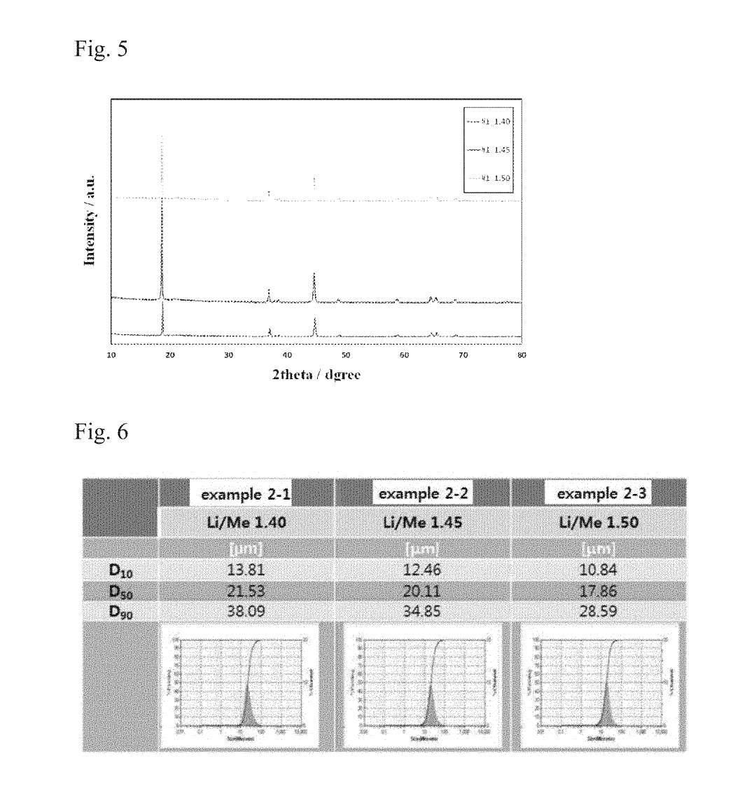

XRD analysis for particles of lithium rich cathode active material which were manufactured in the examples 2-1 through 2-3 were performed, and then the results were shown in FIG. 5. As shown in FIG. 5, the lithium rich cathode active material had a peak at 2θ=21°.

### Test Example 2-2

### Particle Size Analysis

Particle size analysis for particles of lithium rich cathode active material which were manufactured in the examples 2-1 through 2-3 were performed, and then the results were shown in FIG. 6. As shown in FIG. 6, the lithium rich cathode active material manufactured by the example of the present invention had D50 of 17 to 22 μm.

### Test Example 2-3

### SEM Imaging for Active Material

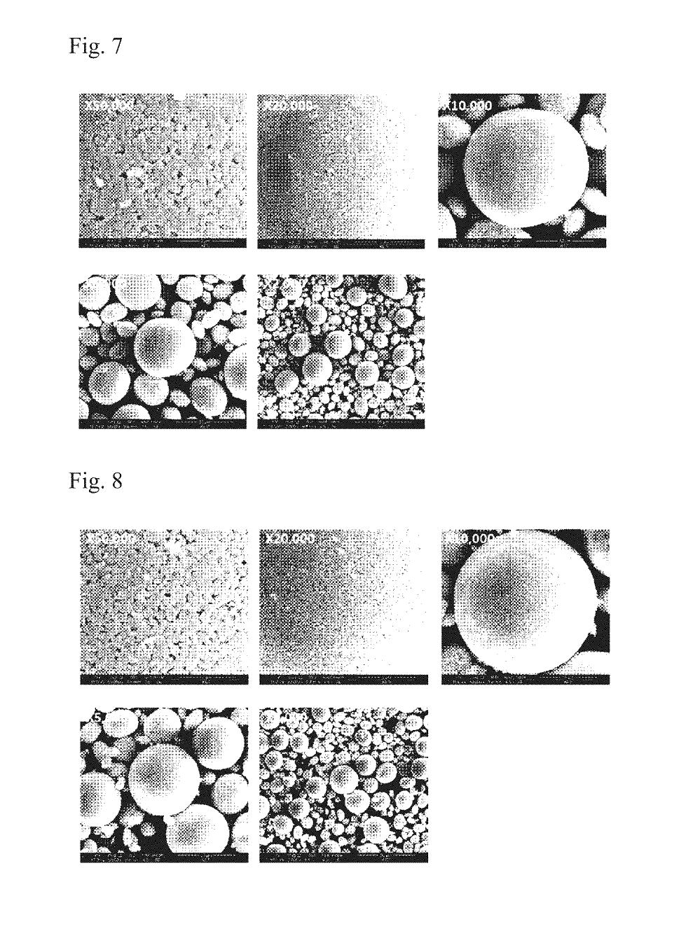

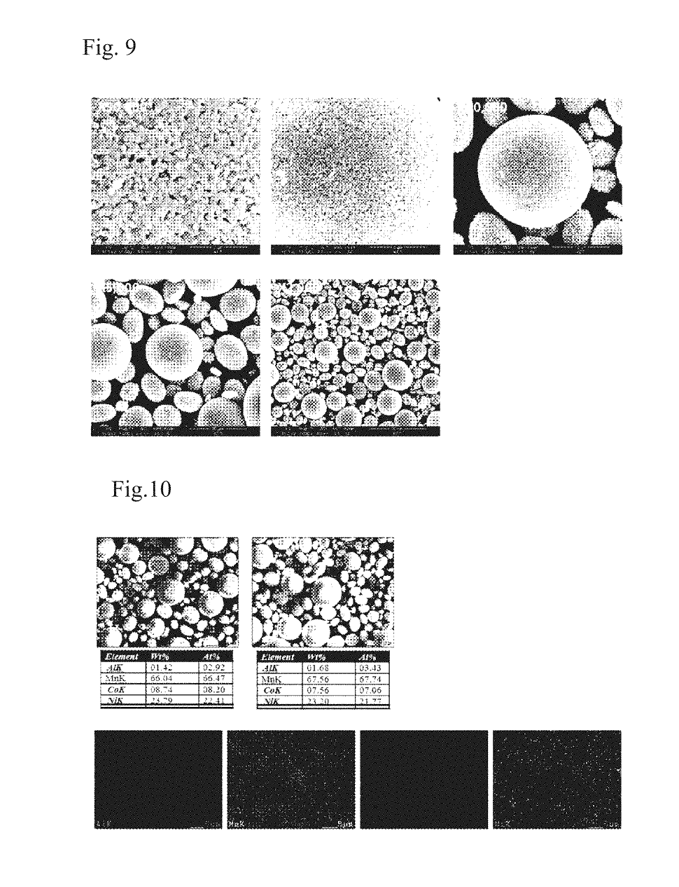

SEM images for particles of lithium rich cathode active material which were manufactured in the examples 2-1 through 2-3 were taken, and then the results were shown in FIGS. 7 to 9. As shown in FIGS. 7 to 9, the particles of the lithium rich cathode active material were secondary particles formed by cohered first particles and had spherical shape.

### Test Example 2-4

### EDS Analysis for Active Material

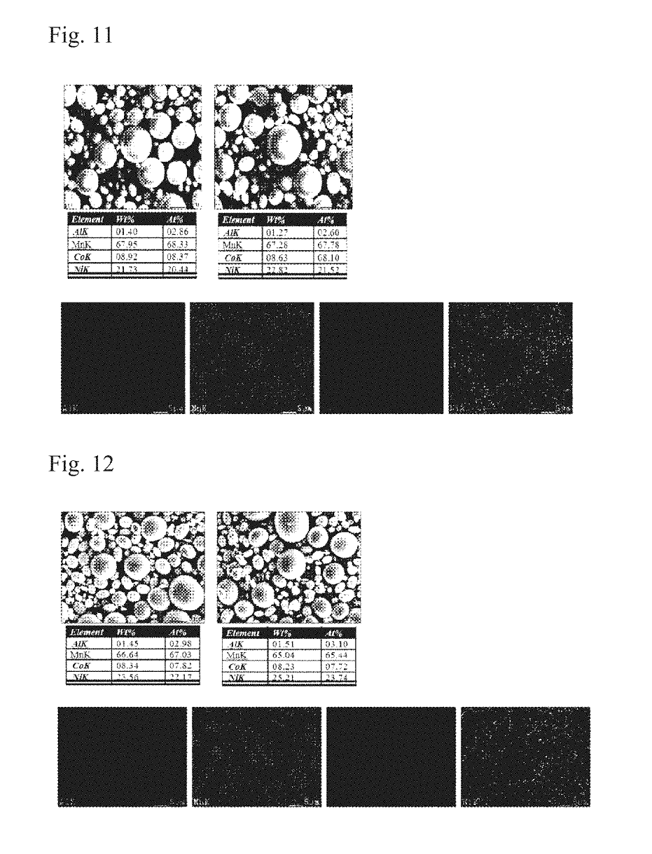

EDS analysis for sections of particles of lithium rich cathode active material which were manufactured in the examples 2-1 through 2-3 were performed, and then the results were shown in FIGS. 10 to 12. As shown in FIGS. 10 to 12, the lithium rich cathode active material was coated by Al.

### Test Example 2-5

### Measuring Charging/Discharging Characteristic

The lithium rich cathode active material manufactured in the examples 2-1 through example 2-3, carbon black and PVDF[Poly(vinylidene fluoride)] as a binder were mixed with organic solution NMP at weight ratio of 94:3:3 to form a slurry. The slurry was coated on an Al foil of 20 um followed by drying, thereby a cathode was manufactured. A CR2016 coin-half cell was assembled using the cathode, an anode of metal lithium and a membrane of a porous poly ethylene film (CellGard 2502). Solution of 1.1M LiPF₆ EC/EMC/DEC was used for electrolyte.

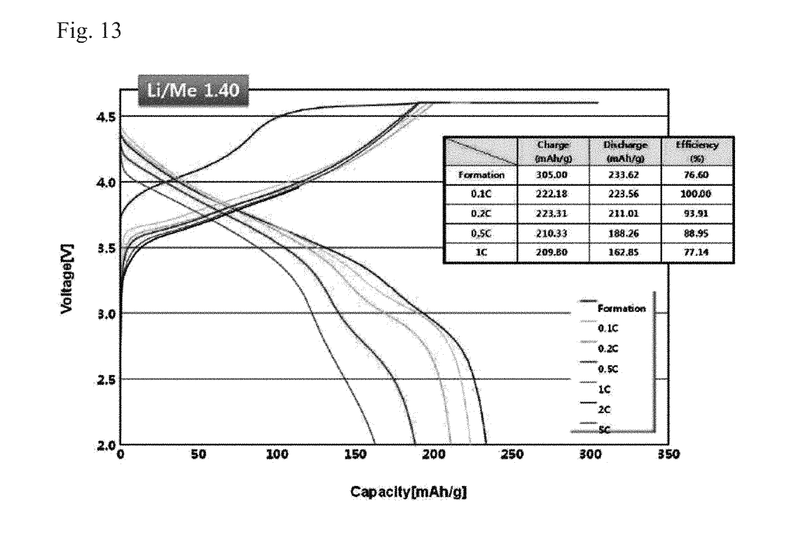

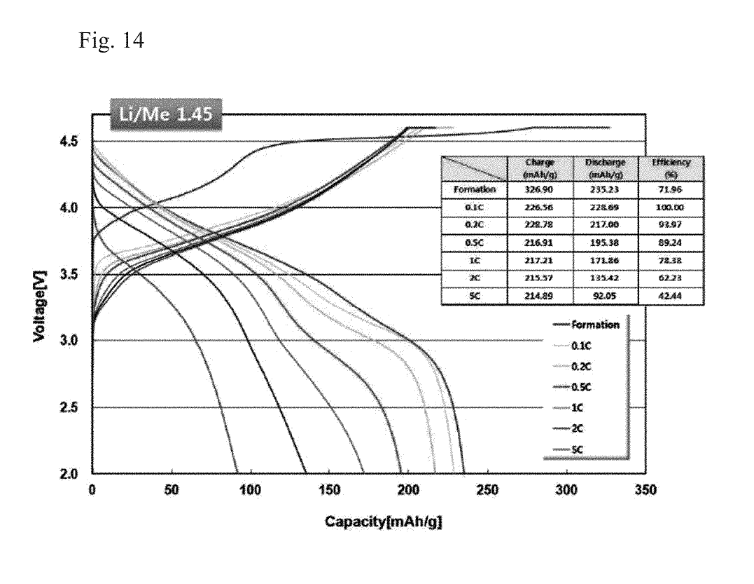

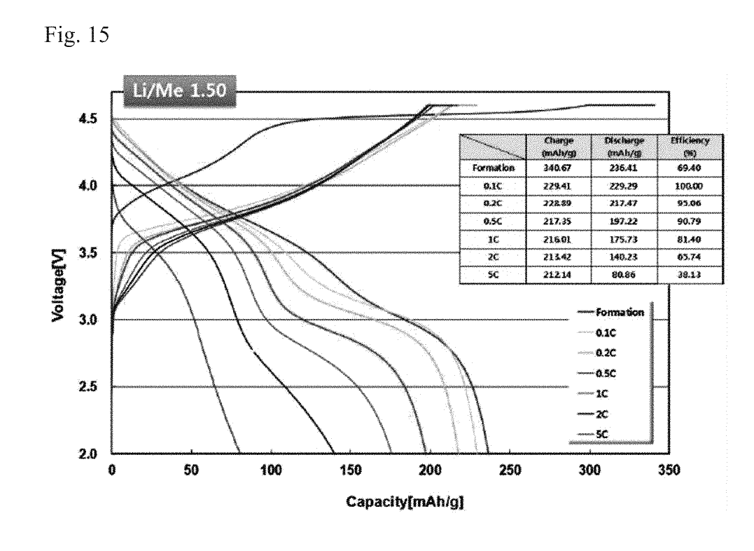

FIGS. 13 to 15 show discharging capacity and cycle life characteristic.

### EXAMPLE 2-6

### Measuring Cycle Life Characteristic

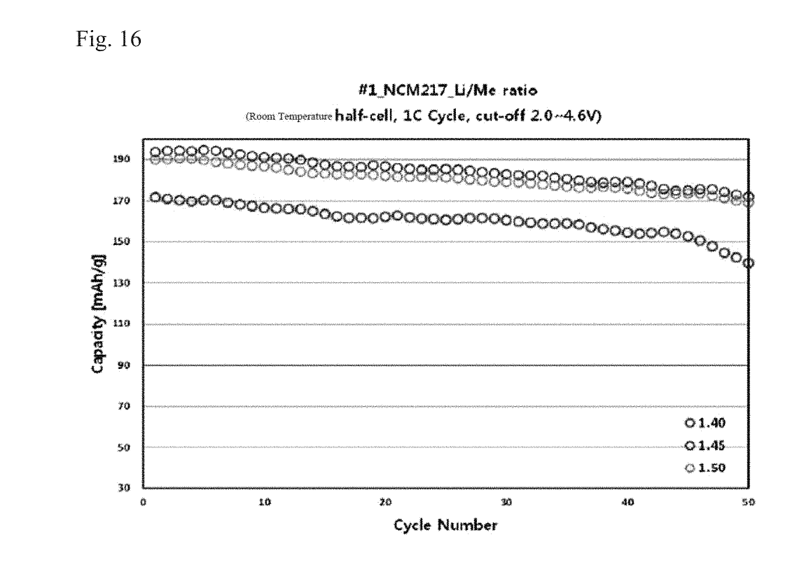

FIG. 16 shows 50 cycle life characteristic of a battery which was manufactured using the lithium rich cathode active material manufactured by the Examples 2-1 through 2-3. It is shown in FIG. 16 that at least 90% of life was sustained when ratio of Li/M is 1.45 and 1.5.

### EXAMPLE 3

### Synthesizing Lithium Rich Cathode Active Material Containing Al 6 Mol %

The carbonate precursor containing Al 6 mol % manufactured in the example 1-2 and Li₂CO₃ as a lithium compound were mixed at equivalent ratio, wherein transition metal ratio was in Table 2 followed by thermal treatment at 900° C. and pulverizing, thereby lithium rich cathode active material was synthesized.

TABLE 3

| | Li/(NiCoMnAl) |
|---|---|
| Example 3-1 | 1.40 |
| Example 3-2 | 1.45 |
| Example 3-3 | 1.50 |

### Test Example 3-1

### XRD Analysis for Active Material

XRD analysis for particles of lithium rich cathode active material which was manufactured in the examples 3-1 through 3-3 was performed, and then the results were shown in FIG. 17. As shown in FIG. 17, the lithium rich cathode active material shows a peak at 2θ=21°.

### Test Example 3-2

### Particle Size Analysis

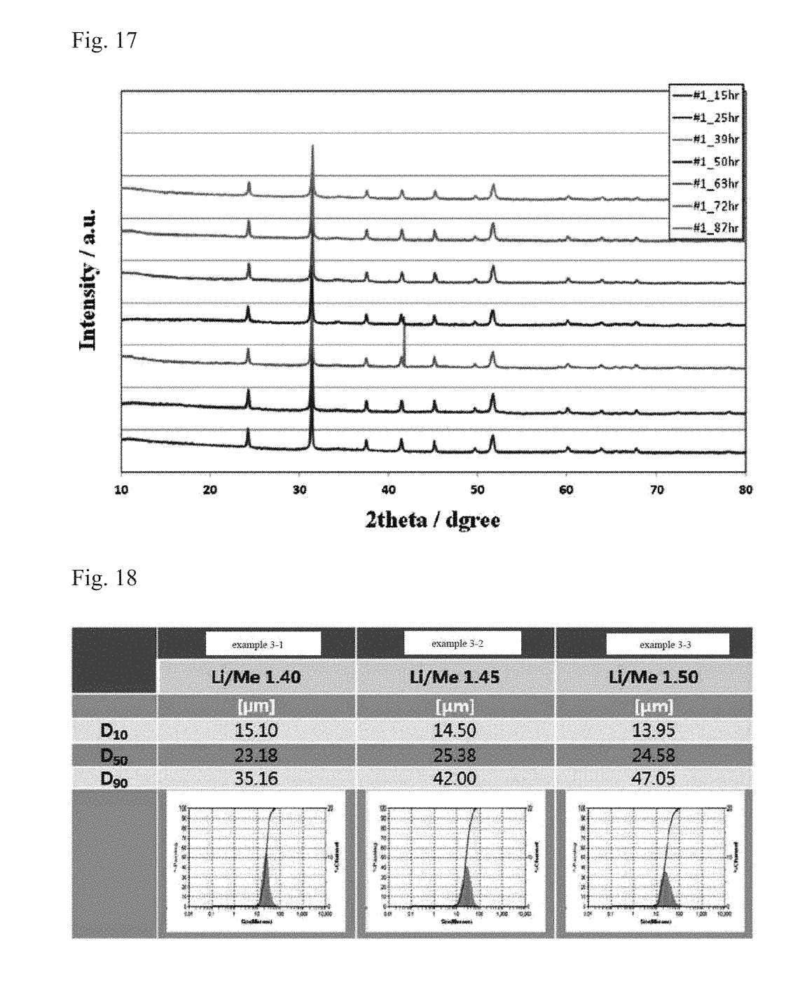

Particle size analysis for particles of lithium rich cathode active material which was manufactured in the example 2-1 through 2-3 was performed, and then the results were shown in FIG. 18. As shown in FIG. 18, the lithium rich cathode active material containing Al 6 mol % manufactured by the examples 3-1 through 3-3 of the present invention had D50 of 23 to 25 μm.

### Test Example 3-3

### Measuring Charging/Discharging Characteristic

The lithium rich cathode active material manufactured in the examples 3-1 through example 3-3, carbon black and PVDF[Poly(vinylidene fluoride)] as a binder were mixed with organic solution NMP at weight ratio of 94:3:3 to form a slurry. The slurry was coated on an Al foil of 20 μm followed by drying, thereby a cathode was manufactured. A CR2016 coin-half cell was assembled using the cathode, an anode of metal lithium and a membrane of a porous poly ethylene film (CellGard 2502). Solution of 1.1M LiPF₆ EC/EMC/DEC was used for electrolyte.

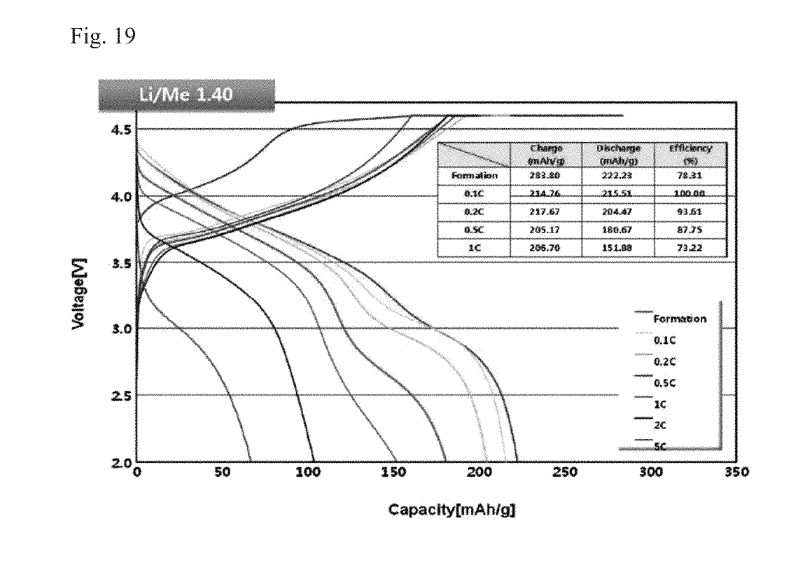

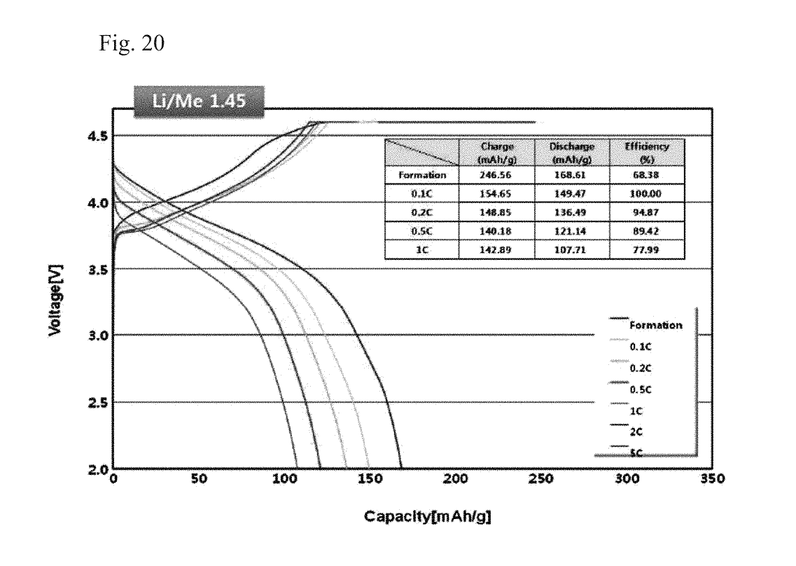

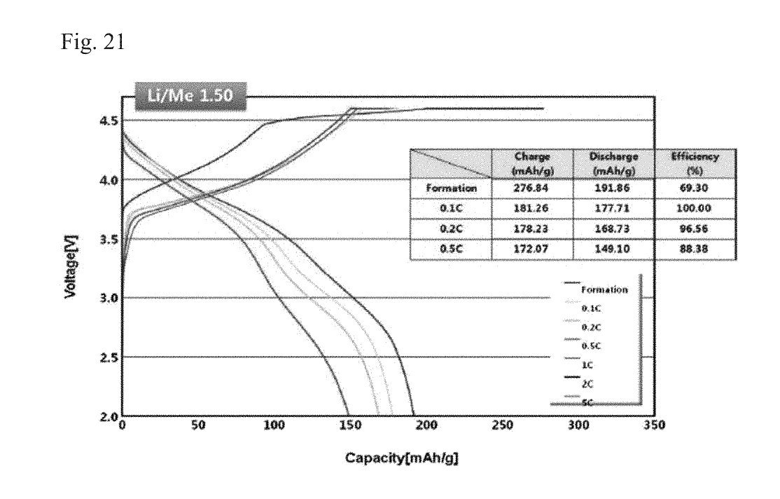

FIGS. 19 to 21 show discharging capacity and cycle life characteristic.

### Test Example 3-4

### Measuring Cycle Life Characteristic

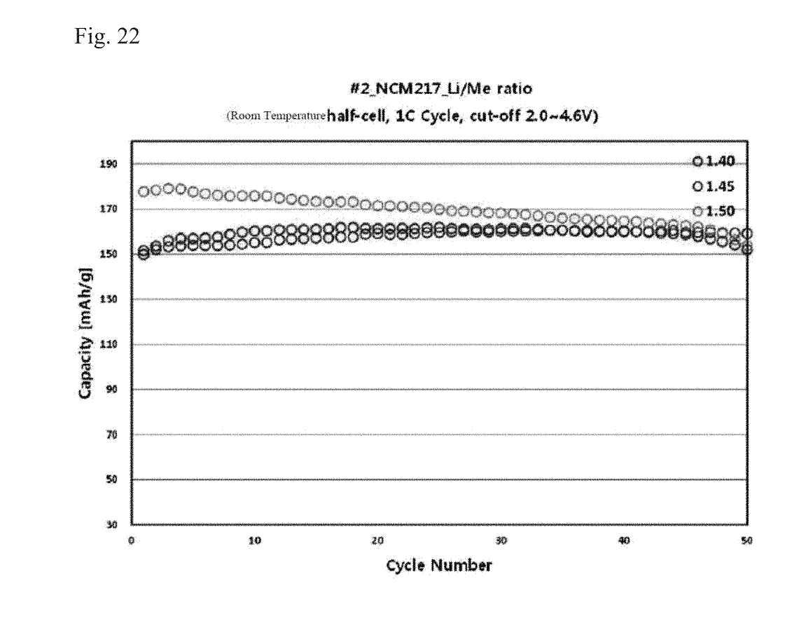

FIG. 22 shows 50 cycle life characteristic of a battery which was manufactured using the lithium rich cathode active material manufactured by the examples 3-1 through 3-3. It is shown in FIG. 16 that at least 90% of life was sustained when ratio of Li/M is 1.45 and 1.5.

### EXAMPLE 4

### Synthesizing a Precursor for Manufacturing Lithium Rich Cathode Active Material

Nickel sulfate hexahydrate (NiSO₄.6H₂O), cobalt sulfate heptahydrate (CoSO₄.7H₂O), manganese sulfate hyemppledrate (MnSO₄.7H₂O), aluminum sulfate as aluminum compound and metal compound solution containing TiO₂ as a different metal was poured into a coprecipitation reactor and continuously supplied to perform coprecipitation reaction for 50 hours while 28% ammonia solution as a complexing agent and Na₂CO₃ as a carbonate compound was continuously supplied to adjust pH as 8 to 10, and then a slurry solution in the reactor was filtrated and washed by ultrapure distilled water followed by drying in a 110° C. vacuum oven for 12 hours, thereby nickel cobalt manganese aluminum titanium metal complex carbonate compound was obtained. This transition metal complex carbonate compound was Ni_{0.2}Co_{0.07}Mn_{0.67}Al_{0.03}Ti_{0.03}CO₃.

TABLE 4

| | Ni | Co | Mn | Al | Ti | Zr | Mg |
|---|---|---|---|---|---|---|---|
| Example 4-1 | 20 | 7 | 67 | 3 | 3 | 0 | 0 |
| Example 4-2 | 20 | 7 | 67 | 3 | 0 | 3 | 3 |
| Example 4-3 | 20 | 7 | 67 | 3 | 0 | 0 | 1 |
| Example 4-4 | 20 | 7 | 67 | 3 | 0 | 0 | 2 |
| Comparative Example 4-1 | 20 | 10 | 70 | 0 | 0 | 0 | 0 |
| Comparative Example 4-2 | 20 | 7 | 70 | 3 | 0 | 0 | 0 |
| Comparative Example 4-3 | 20 | 7 | 67 | 0 | 3 | 0 | 0 |
| Comparative Example 4-4 | 20 | 7 | 67 | 0 | 0 | 3 | 3 |
| Comparative Example 4-5 | 20 | 7 | 64 | 3 | 6 | 0 | 0 |
| Comparative Example 4-6 | 20 | 7 | 64 | 3 | 0 | 6 | 6 |

Precursor of the examples 4-2 through 4-4 and the comparative examples 4-1 through 4-6 were synthesized using the same condition except for manufacturing metal compound solution using compound rate in Table 4.

### Test Example

### SEM Imaging and EDS Analysis

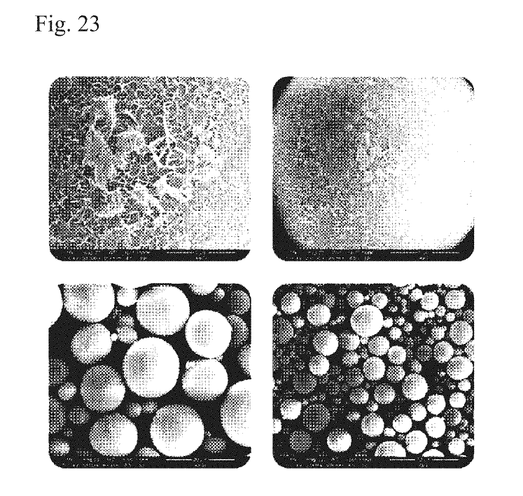

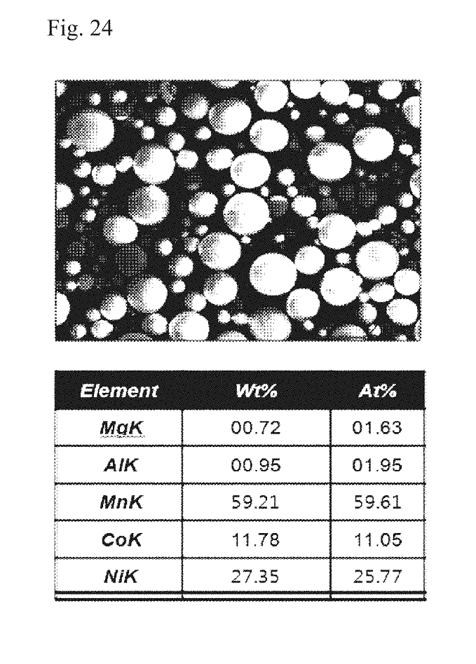

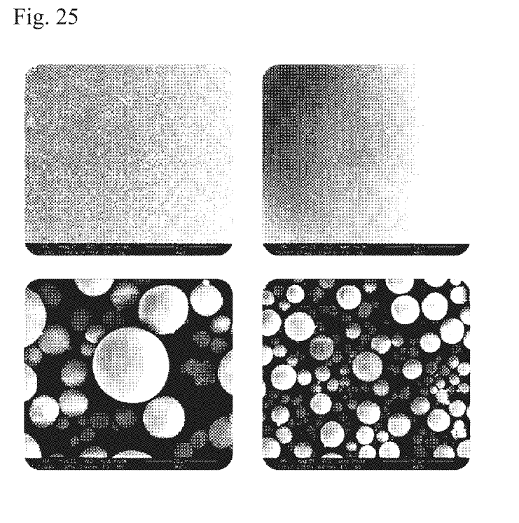

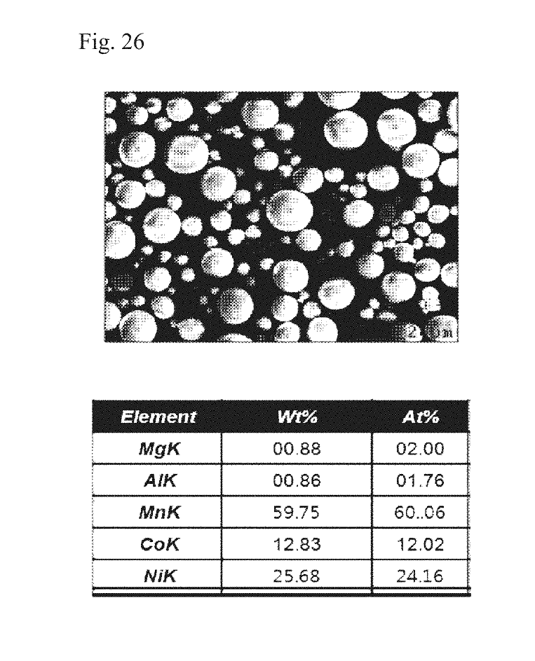

Results of SEM images and EDS analysis of precursor manufactured by the example 4-3 was shown in FIGS. 23 and 24, and results of SEM images and EDS analysis of precursor for manufacturing lithium rich cathode active material which was manufactured at constituent of the example 4-4 was shown in FIGS. 25 and 26.

The SEM images in FIGS. 23 and 25 shows that Al₂O₃ coated on a surface was cohered, and the result of the EDS measurement shows indicates that doped Al and Mg are coated on particles uniformly.

### EXAMPLE 5

### Synthesis of Lithium Rich Cathode Active Material

The carbonate precursor manufactured in the examples 4-1 through 4-4 and the comparative example and Li₂CO₃ as a lithium compound were mixed at equivalent ratio followed by thermal treatment at 900° C. and pulverizing, thereby lithium rich cathode active material was synthesized.

### Test Example

### SEM Imaging and EDS Analysis

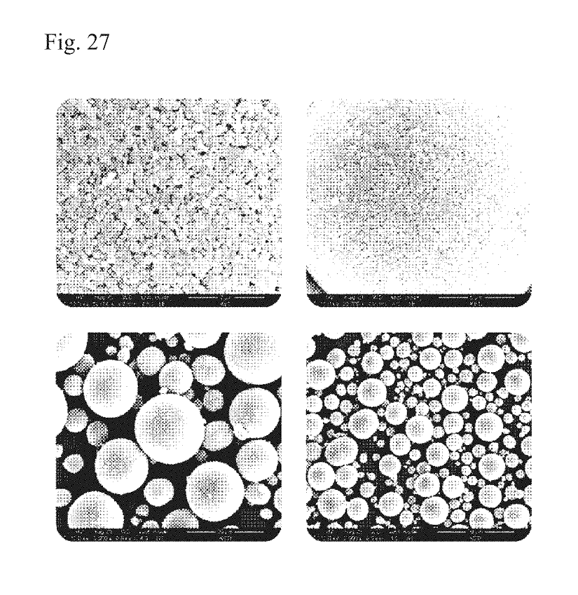

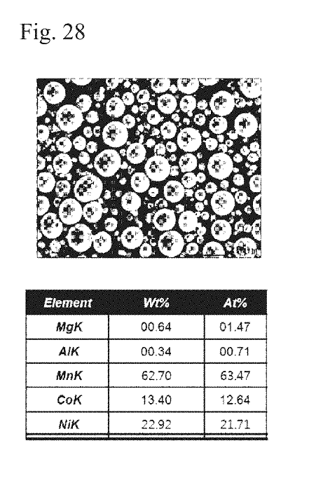

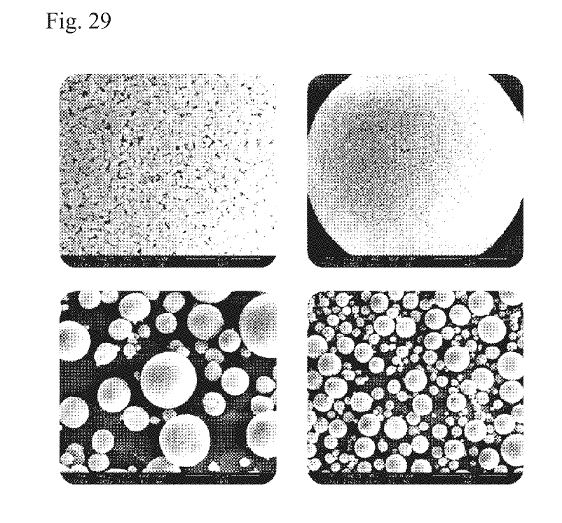

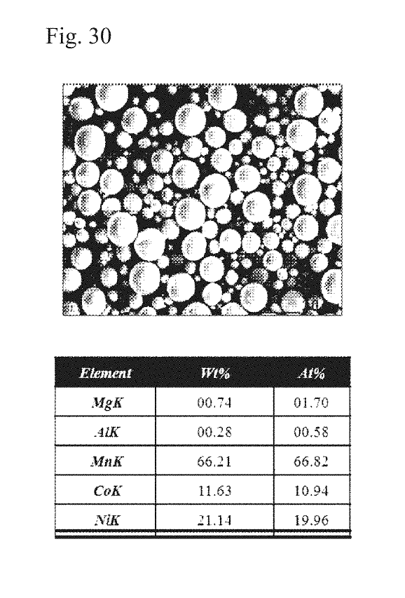

Results of SEM images and EDS analysis of the example 5-3 which is lithium rich cathode active material manufactured at the precursor constituent of the example 4-3 was shown in FIGS. 27 and 28, and results of SEM images and EDS analysis of the example 5-4 which is lithium rich cathode active material manufactured at the constituent of the example 4-4 was shown in FIGS. 29 and 30.

### Test Example

### Measuring Battery Properties

The lithium rich cathode active materials of the examples 5-1 through 5-4 and the examples comparative examples 5-1 through 5-6 manufactured by the example 4-1 through 4-4 and the comparative examples 4-1 through 4-6, carbon black and PVDF[Poly(vinylidene fluoride)] as a binder were mixed with organic solution NMP at weight ratio of 94:3:3 to form a slurry.

The slurry was coated on an Al foil of 20 μm followed by drying, thereby a cathode was manufactured. A CR2016 coin-half cell was assembled using the cathode, an anode of metal lithium and a membrane of a porous poly ethylene film (CellGard 2502). Solution of 1.1M LiPF₆ EC/EMC/DEC was used for electrolyte.

Following Table 5 shows discharging capacity and cycle life characteristic.

TABLE 5

| | Discharge | Room Temperature life |
|---|---|---|
| | Capacity/mAhg-1 | after 50 cycles/% |
| Example 5-1 | 249 | 95 |
| Example 5-2 | 250 | 96 |
| Comparative Example 5-1 | 261 | 87 |
| Comparative Example 5-2 | 259 | 93 |
| Comparative Example 5-3 | 254 | 92 |
| Comparative Example 5-4 | 253 | 93 |
| Comparative Example 5-5 | 240 | 92 |
| Comparative Example 5-6 | 239 | 93 |

As shown in Table 5, the lithium rich cathode active material according to examples of the present invention is more improved than the comparative examples in discharging capacity and cycle life characteristic.

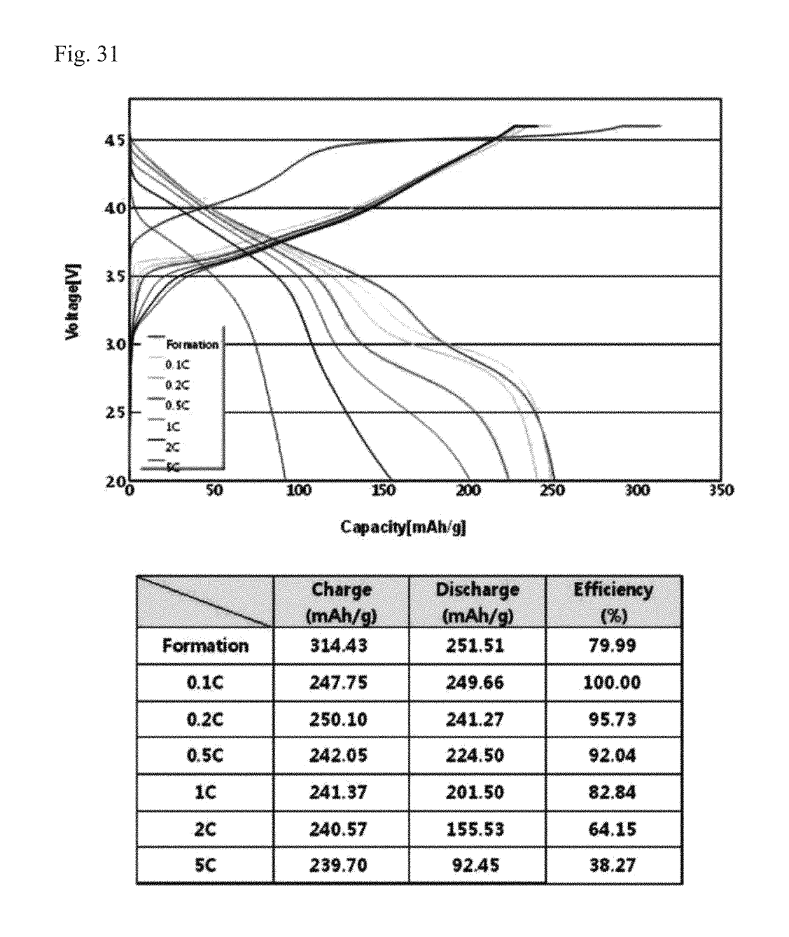

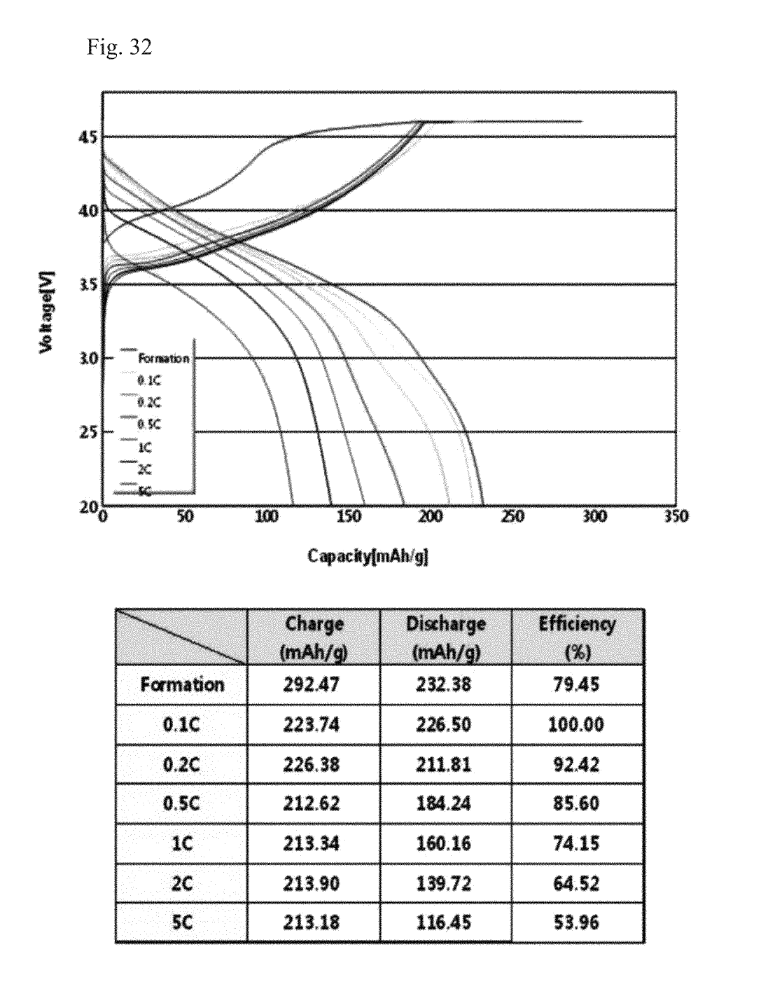

FIGS. 31 and 32 show results of charging/discharging characteristics of CR2016 coin-half cells using the lithium rich cathode active materials at the constituents of the examples 5-3 and 5-4.

### Test Example

### Measuring Cycle Life Characteristic

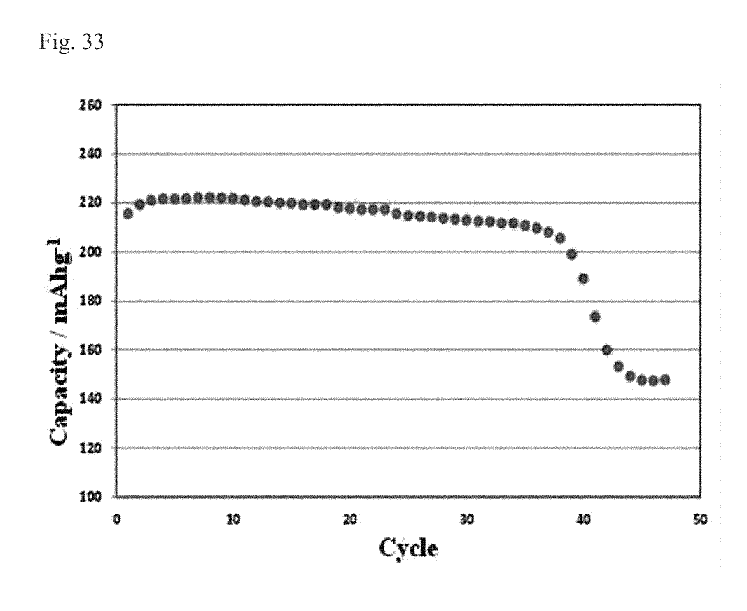

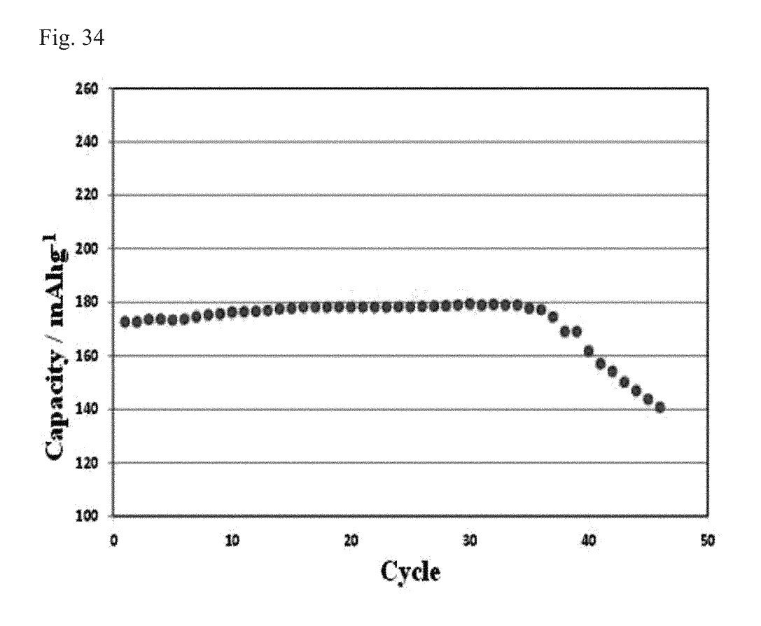

FIGS. 33 and 34 show cycle life characteristics of the CR2016 coin-half cells using the lithium rich cathode active materials of the examples 5-3 and 5-4 which are manufactured at constituents of the examples 4-3 and 4-4.

As shown in FIGS. 33 and 34, the CR2016 coin-half cells using the lithium rich cathode active materials of the examples 5-3 and 5-4 which are manufactured at constituents of the examples 4-3 and 4-4 maintain capacities until 40 cycles.

### Test Example

### Measuring Particle Intensity

Following Table 6 shows particle intensities of the lithium rich cathode active materials of the examples 5-3 and 5-4 which are manufactured at constituents of the comparative examples 4-3 and 4-4, and particle intensities of the lithium rich cathode active materials of the comparative examples 5-3 and 5-4 which are manufactured at constituents of the examples 4-3 and 4-4.

TABLE 6

| | ID | Particle hardness |
|---|---|---|
| Comparative Example 5-1 | bare | 101 |
| Comparative Example 5-2 | Al 0.3 | 111 |
| Example 5-3 | Al 0.3 Mg1 | 116 |
| Example 5-4 | Al 0.3 Mg2 | 116 |

According to the present invention, a battery, of which high voltage capacity is improved and cycle life characteristics are improved, can be fabricated by adjusting species and a composition of substituted metal and by adjusting species and an amount of substituting metal, in the precursor for manufacturing lithium rich cathode active material and the lithium rich cathode active material using the same.

According to the precursor for manufacturing lithium rich cathode active material and the lithium rich cathode active material using the same, species and content of substituted metal from the precursor are adjust and species and addition amount of substituting metal are adjust to manufacture a battery of which high voltage properties and cycle life characteristics are improved.

What is claimed is:

1. A precursor for manufacturing lithium rich cathode active material expressed by following chemical formula 2:
Ni_{α2}Mn_{β2-y2}CO_{γ2-δ2}AL_{δ2}A_{y2}CO₃ [Chemical formula 2]
wherein in the chemical formula 2, A is selected from the group consisting of Mg, Ti and Zr; α2 is 0.05 to 0.4; β2 is 0.5 to 0.8; γ2 is 0 to 0.4; δ1 is 0.001 to 0.1; and y2 is 0.001 to 0.1.

2. The precursor for manufacturing lithium rich cathode active material of claim 1, wherein the particle diameter of the precursor for manufacturing lithium rich cathode active material is 5 to 25 μm.

3. Lithium rich cathode active material expressed by following chemical formula 4, which is manufactured from the precursor for manufacturing lithium rich cathode active material of claim 1:
Li₁₊ₓ₂Ni_{α2}Mn_{β2-y2}CO_{γ2-δ2}Al_{δ2}A_{y2}O₂ [Chemical formula 4]
wherein in the chemical formula 4, x2 is 0.2 to 0.7; A is selected from the group consisting of Mg, Ti, and Zr; α2 is 0.05 to 0.4; β2 is 0.5 to 0.8; γ2 is 0 to 0.4; δ2 is 0.001 to 0.1;
and y2 is 0.001 to 0.1.

4. The lithium rich cathode active material of claim 3, wherein the lithium rich cathode active material is xLiMAl_{δ2}O₂.(1-x)Li₂Mn_{1-y2}A_{y2}O₃, wherein 0<x<1, M is a compound of Ni, Co, and Mn; A is selected from the group consisting Mg, Ti, and Zr; δ2 is 0.001 to 0.1; and y2 is 0.001 to 0.1.

5. The lithium rich cathode active material of claim 3, wherein the lithium rich cathode active material is a layered structural composite.

6. The lithium rich cathode active material of claim 3, wherein Al content: δ2, Li content: x2 and different metal A content: y2 satisfy following relative formula,
x2δ2 and
y2δ2.

7. The lithium rich cathode active material of claim 3, wherein particle intensity of the lithium rich cathode active material is at least 115 Mpa.
